(19) United States
(12) Patent Application Publication
(10) Pub. No.: US 2002/0128910 A1
(43) Pub. Date: Sep. 12, 2002

(54) Business supporting system and business supporting method

(76) Inventor: Takuya Sakuma, Saitama (JP)

Correspondence Address: Dowell & Dowell, P.C., Suite 309, 1215 Jefferson Davis Highway, Arlington, VA, 22202, US

(21) Appl. No.: 10/040,439

(22) Filed: Jan. 9, 2002

(30) Foreign Application Priority Data
Jan. 10, 2001 (JP) 2001-2479
Mar. 5, 2001 (JP) 2001-60994
Dec. 13, 2001 (JP) 2001-379850

(51) Int. Cl. G06F 17/60

(52) U.S. Cl. 705/14

(57) ABSTRACT

A business supporting system extracts prospective customers to whom purchase of a new product is to be proposed, based on properties of products, relations between the products, purchase history and so forth. Moreover, prospective customers may be extracted based on results of previous purchases, accounting data analysis and customer trouble analysis, so as to meet requirements of a seller and to also meet the needs of customers. Extracting conditions can be defined at the seller's option.

### BACKGROUND OF THE INVENTION

1. Field of the Invention

The present invention relates to a business supporting system used to support business in electronic commercial transactions (so-called electronic commerce), business at call centers or other ordinary business dealings, and also relates to a business supporting method, programs and recording media therefor.

2. Description of the Related Art

There are business techniques such as database marketing for supporting business with scientific techniques and one-toone marketing or CRM (Customer Relationship Management) for pursuing business with each customer, based on the analysis of customer data stored in the computer. These techniques are considered effective and expected to produce excellent results if successfully applied.

The conventional CRM system in what is now called electronic commerce or e-commerce will be taken as an example and described with reference to FIGS. 11 and 12. In FIG. 11, customers 1 purchase goods by accessing an electronic commerce server (site) 3 over the Internet 2. Data on a customer 1 are stored in a customer data memory 5, data on contracts between the customer 1 and a goods provider (provider of server 3) are stored in a contract data memory 7, and data on a behavior of the customer 1 on the Web provided by the server 3 are stored in a web-click data memory 10. Then, at predetermined or specified timings, managerial accounting data on the customers are calculated from customer data and stored in a managerial accounting data memory 6.

In FIG. 12, various data on customers stored in memories 4 to 7 are analyzed by manual operation (S100) and prospective customers who are expected and likely to purchase certain goods are extracted. Based on the results of this analysis, business is conducted by outbound marketing using telephone, direct mail and electronic mail (Email) (S101). For example, a campaign for a specific product is carried out for the customers. This kind of outbound marketing requires lower personnel expenses and are very effective as an efficient low-cost business.

As described above, outbound marketing based on the analysis of customer data for prospects has already been in practice. This mode of business practice, however, requires trend analysis of a group of customers and involves problems of heavy system investment, installation of a marketing department and its cost, inadequate skill of marketing and so forth. Due to the manpower and cost problems, therefore, it is a fact that this business approach has not been so successful except with a limited number of large enterprises.

### SUMMARY OF THE INVENTION

The present invention was made by the inventor based on the above circumstances, and an object thereof is to provide a technique to extract customers who are expected or likely to purchase goods by a method expedient to both sellers and customers. Another object is to provide a technique to realize a product recommendation or proposal that meets demands by both sellers and customers.

As described above, in structuring a CRM system to realize one-to-one marketing for each customer with emphasis on customer data, one has often faced difficulties in acquiring meaningful attribute data on customers or high cost in creating a system for acquiring such data. Moreover, the cost of constructing a customer database has often been extremely high because an enormous amount of data is required to incorporate as many data items of customer attributes as possible and to prepare data for each of the customers.

Both the hypothesis and verification technique and the data mining technique for the analysis of customer data have not, in fact, proven their worth simply because they depend heavily on the know-how of the analyzer to ensure the meaning and validity of the analysis.

In electronic commerce, which is now definitely on the rise in business transactions, a technique called personalization is used to switch the display contents of the Web screen according to the attributes, such as preference, of each customer stored in a database or the like when the customer visits the Web site. And taking the customer access history, contact information and trouble information into the computer as digital information is gradually realized, and the personalization using the information is being realized. These techniques, called eCRM, are expected to come into wider use in the future. These techniques, however, are only used in switching the display contents according to the attributes of the customer who visits the Web site, and cannot be considered part of positive sales activities. Moreover, without the function of extracting prospective customers, which the present invention provides, they do not constitute a positive sales activity called outbound marketing.

Customer data collected to realize “one-to-one marketing-type customer service to meet the needs of individual customers” in CRM are often used for the convenience or advantage of the selling enterprise only. CRM, therefore, is confronted by fundamental problems that customers do not appreciate the selling enterprise using their personal data to its own advantage and that customers do not fully trust the selling enterprise even if it promises that it will not make an illicit use of their personal data. While it provides convenience to the customers, CRM does not offer much other customer servicing, and, to make matters worse, CRM has a negative aspect of being regarded by the customers with suspicion.

The business supporting system and method, designed to minimize customer data whose collection is quite costly, according to the present invention structures a minimum customer database containing a customers' product-purchase-record database, then structures a database of seller-side product information, and extracts prospective customers from these databases automatically.

A product information database is not particularly large in size because the number of products is, by nature, smaller compared to the number of customers. A smaller size of customer database will significantly reduce the cost of hardware and the cost of system structuring.

The business supporting system and method according to the present invention extract prospective customers automatically, so that the user of this system or method is not required to have the expert knowledge of data mining and the like and it is not necessary to establish a marketing organization to introduce this system or method. Moreover, the extraction of prospective customers by this system or method allows the user to carry out positive outbound marketing with better results.

The business supporting system and method according to the present invention presents a concept where prospective customers are extracted from a well-defined and logical viewpoint without resorting to the ambiguous methodology of data mining, while the high hurdles for the intake of customer data and the high cost of customer database structuring are avoided. Using the clearly defined characteristics of products (replacement after the durable period, upgrading, maintenance) and clearly defined relations between products (bundle affinity, rarity of simultaneous purchase, parts or components), cross-selling, up-selling and replacement are promoted, so that the probability of order received is basically higher than in ordinary sales activities. For example:

A certain ink-jet printer and its consumables, such as the exclusive-use ink-jet cartridge and paper.

A systematically equipped kitchen or system kitchen and the dedicated accessories and detergent therefor.

Service of upgrading and installation of an extended disk, extended memory or CPU that have specifications capable of being connected to a personal computer.

The business supporting system and method according to the present invention are a general-use system and method applicable to any type of business by customizing the product information database and customer information database.

An embodiment of the present invention relates to a business supporting method. This method includes: extracting a prospective customer who indicates a demand for at least one of a cross-sell, up-sell and replacement to a new product, based on at least one of a property of products, a relation between the products, a customer product purchase history and a contact history from customers; and displaying the prospective customer on a screen, whereby customers having potential demands are revealed. “Product” as meant here is not only limited to material or an object to be purchased, but also includes a servicing and so forth.

Another embodiment of the present invention relates to a business supporting system. This system comprises: a product information storage which stores at least one of a property of products and a relation between the products; a customer information storage which stores a customer product purchase history; an extracting condition generator which generates a condition for extracting a prospective customer who indicates a demand for at least one of a cross-sell, up-sell and replacement to a new product, based on at least one of the property of products and the relation between the products and based on the customer product purchase history; and an extraction processing unit which extracts the prospective customer based on the condition.

The system according to the present embodiments includes two cases where (1) the system is specified as a server or a user terminal placed on a network and (2) the system is a system comprised of a server and a user terminal connected through a network. Each functional block of the product information storage and customer information storage, extracting condition generator and extraction processing unit may be provided at either the server side or the user terminal side. Those functional blocks may also be provided at both the server and the user terminal, and in this case each functional block may have the same designation or name. These individual functions are provided in the form of program modules, and may be executed at either of the server or the user terminal, or at both server and the user terminal, and moreover, may be downloaded from the server to the user terminal in the execution thereof.

The concepts of the business supporting system, method and program of eCRM according to the present invention include:

(1) Prospective customers are extracted automatically and promptly.

Extraction of customers with potential demand.

Extraction of customers who shows some signs of willingness to purchase.

A specialized or dedicated marketing organization is not required.

After a campaign for a product sale is conduced, the results of after and before the campaign can be verified and compared. Moreover, the customer extraction can be repeated with greater accuracy, by examining and modifying the extracting conditions.

(2) Very promising customers are extracted.

For example, customers whose sales are increasing are extracted from the time-series analysis of managerial accounting data.

For example, customers from whom profits are likely to be generated are extracted from the time-series analysis of managerial accounting data.

(3) Customers who are in need of customer maintenance are extracted.

For example, customers who are in need of customer maintenance are speedily extracted from customer trouble data or customer access history.

Necessary actions and steps are taken, without fail, to customers who are in need of customer maintenance, from the customer trouble data or the customer access history.

It is to be noted that addition to, replacement or substitution of the above-described structural components, features and elements may be made. The components, features and elements added, replaced or substituted in part or whole between a method and a system, and components, features and elements changed to a computer program, recorded on a recording medium or the like, are all effective as and encompassed by the present embodiments.

Moreover, this summary of the invention does not necessarily describe all necessary features so that the invention may also be a sub-combination of these described features.

### BRIEF DESCRIPTION OF THE DRAWINGS

FIG. 1 illustrates a business supporting system according to an embodiment of the present invention.

FIG. 2 is a flowchart showing operations of the business supporting system of FIG. 1.

FIG. 3 shows a block diagram for the business supporting system of FIG. 1.

FIG. 4 is a flow chart showing a customer extraction processing in the business supporting system of FIG. 1.

FIG. 5 shows exemplary customer attribute information in the business supporting system of FIG. 1.

FIG. 6 shows exemplary product information in the business supporting system of FIG. 1.

FIG. 7 shows exemplary customer contact information in the business supporting system of FIG. 1.

FIG. 8 shows exemplary customer contact information in the business supporting system of FIG. 1.

FIG. 9 shows exemplary customer trouble information in the business supporting of FIG. 1.

FIG. 10 shows exemplary virtual attributes in the business supporting system of FIG. 1.

FIG. 11 illustrates conventional electronic commercial transactions.

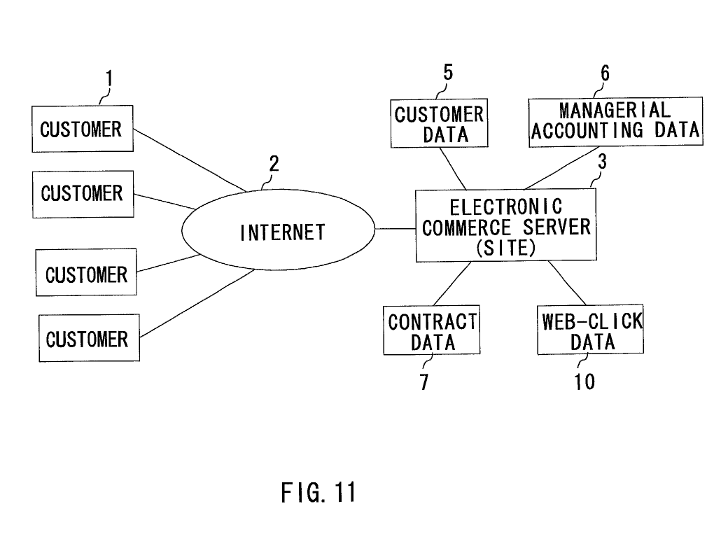

FIG. 12 illustrates operations in conventional electronic commercial transactions.

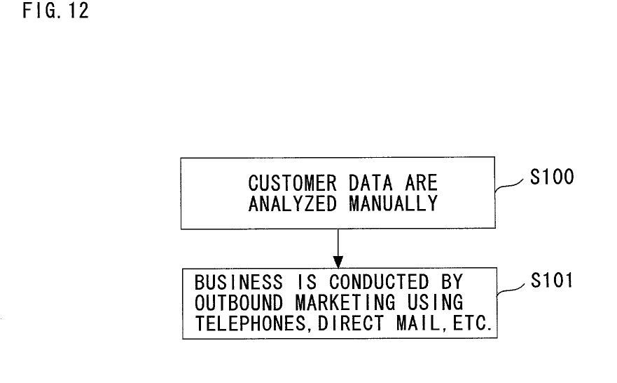

FIG. 13 illustrates a solution or a set of products.

FIG. 14 is a functional block diagram showing a structure of a business supporting system according to another embodiment of the present invention.

FIG. 15 is a functional block diagram showing a detailed structure of an extracting condition generator.

FIG. 16 is a flowchart showing a process of extracting prospective customers.

### DETAILED DESCRIPTION OF THE INVENTION

The invention will now be described based on the preferred embodiments, which are not intended to limit the scope of the present invention, but exemplify the invention. All of the features and the combinations thereof described in the embodiment are not necessarily essential to the invention.

First Embodiment

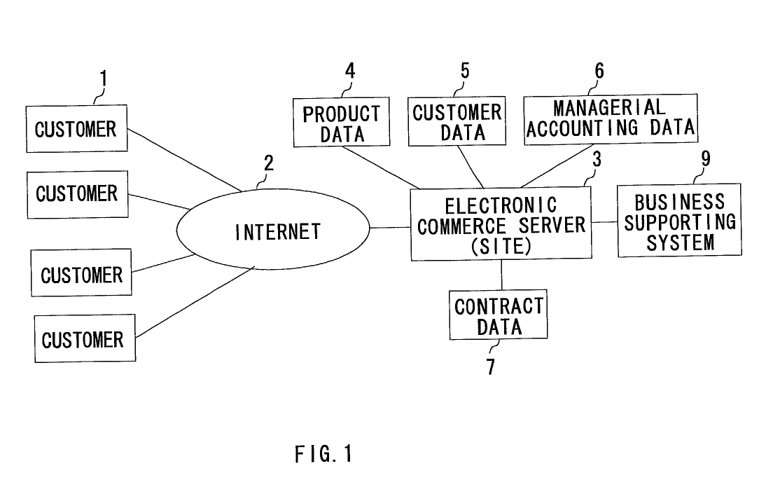

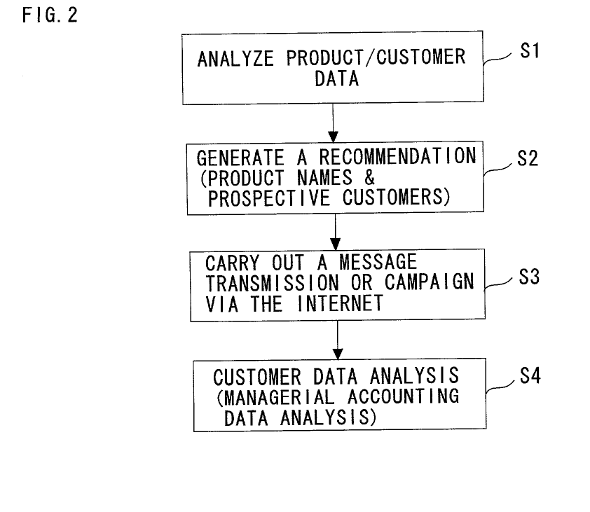

A CRM business supporting system will now be described according to preferred embodiments of the present invention. This system is designed to present or propose prospective customers for certain goods. A general outline of a system according to the embodiments of the present invention will be described with reference to FIG. 1 and FIG. 2, taking, as an example, a case in so-called electronic commercial transactions (electronic commerce). In FIG. 1, customers 1 purchase goods by accessing an electronic commerce server (site) 3 via the Internet 2. Data on products, goods and services (referred to as “products”) are stored in a product data memory 4. Data on a customer 1, including information on the purchases of goods by the customer, are stored in a customer data memory 5, data on contracts between the customer 1 and a goods provider (provider of server 3) are stored in a contract data memory 7, and data on the behavior of the customer 1 on the Web presented by the server 3 are also stored in the memory customer data 5. Generally at the end of each month, managerial accounting data are calculated from customer data, product data, and contract data and stored in a managerial accounting data memory 6. A business supporting system 9 can analyze various data on goods and customers stored in the memories 4 to 7, extract customers according to predetermined conditions and analyze managerial accounting data, and further narrow down customers or extract them anew. Moreover, the effects of business by an outbound marketing of this system is measured using this managerial accounting data analysis function.

As shown in FIG. 2, this system analyzes various data on merchandise and customers stored in the memories 4 to 7 (S1). Then, based on the results of this analysis, a recommendation is generated “which specifies prospective customers for a certain product” (S2), and a message transmission or a campaign is carried out via the Internet (S3). Then, at an arbitrary point after the campaign, the managerial accounting data on the customers are analyzed, and the campaign's effects are measured (S4).

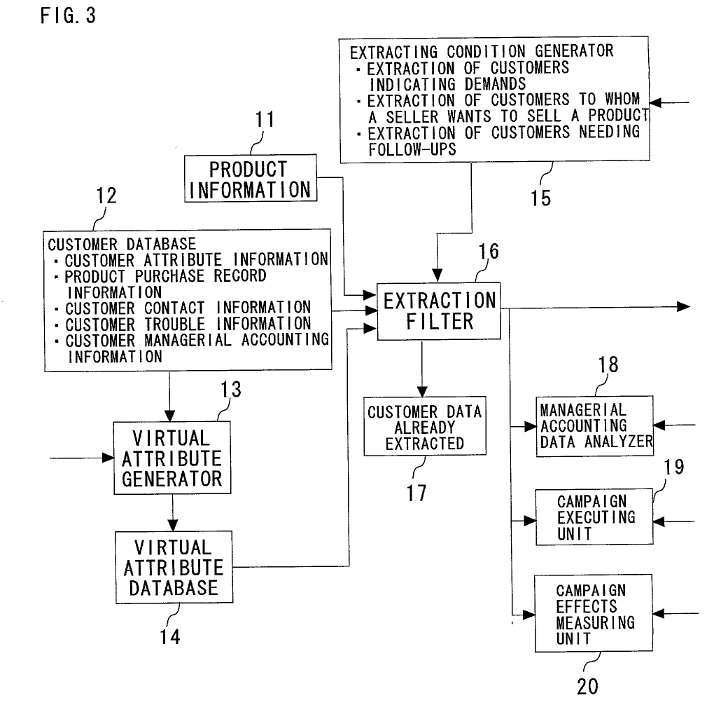

FIG. 3 is a block diagram showing this system. FIG. 3 illustrates an internal structure of the business supporting system shown in FIG. 1. Data as listed herein are included in items of a customer database. The business supporting system includes a product information memory 11, customer database 12, a virtual attribute generator 13 which generates virtual attributes of customers from data in the customer database 12, a virtual attribute database 14, an extracting condition generator 15, an extraction filter 16 which extracts predetermined customer data from the customer database 12 according to a generated extracting condition, an extracted customer data memory 17, a managerial accounting data analyzer 18 which analyzes managerial accounting data on customers, a campaign executing unit 19 which carries out campaigns, and a campaign effects measuring unit 20 which measures the effects of campaigns.

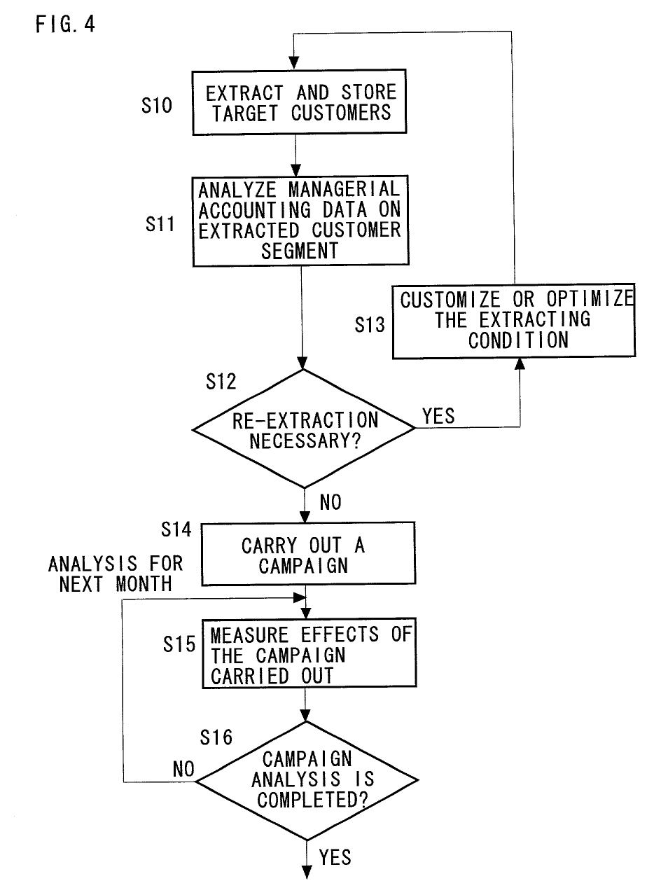

FIG. 4 shows an outline of operations of this system. First, a predetermined extracting condition is set, then target customers are extracted according to a predetermined condition, and, as needed, the extracted customer data are stored in the memory 17 (S10). Namely, applicable customers are listed up, using the extracting conditions prepared on this system in advance or the combined or customized extracting conditions thereof. This customer list is stored and can be put to repeated use later. The same is true with customized extracting conditions.

The managerial accounting data on the extracted customer segment are analyzed (S11). The managerial accounting data on the customer segment extracted in S10 are analyzed (S11). According as necessity arises, a time-series analysis of data from the past is carried out.

When the result of extraction is not the desired one (S12: Re-extraction Necessary?=YES), the extracting condition is customized or optimized (S13). When it is necessary to re-extract the customer list as a result of the customer segment analysis in Sll, the extracting conditions are customized or optimized. Customization of extracting conditions is done by combining, inheriting the extracting conditions prepared by the system or adding new extracting conditions thereto. Then a customer list is re-extracted, using the extracting conditions thus customized. The processes S10 to S13 are repeated until desired results are obtained.

Then a campaign is carried out based on the results of the extraction (S14). Then, a campaign effects analysis is conducted to measure the effects of the campaign (S15). A comparative analysis is made on the managerial accounting data (sales, profits, costs and so forth) taken before and after the campaign or at a plurality of arbitrary points of time. The performance of the campaign can be easily analyzed by monthly performing a managerial accounting analysis of the customer segment for which the campaign was launched, until the campaign analysis is completed (S16).

Furthermore, the present system provides the following functions:

Function (1)

Listing up of customer IDs of a customer group extracted by a filter.

Storage of the extracted customer ID list.

List display and selection of the filter.

Overwrite editing and storage of the existing filter (including a system filter).

Definition of a new filter (combination of existing filters) and storage thereof.

Function (2)

Selection of a customer group for list display and analysis of the stored customer ID lists.

Display of analysis data (time-series data on sales, profits and costs of customers or customer group).

List display and selection of display information settings of analysis data.

Display of analysis data, using a selected customer ID list and selected display information settings.

Exporting of displayed analysis data.

Function (3)

List display and selection of the customization history of a filter.

Function (4)

Storage and reference of campaign execution contents (contents description, campaign setting date, ID list of customer groups, filters used, display information settings used, managerial accounting data on sales, profits and costs of the customer group as a whole in the month preceding the campaign setting date).

After the completion of a campaign, a comparative analysis and time-series analysis of the managerial accounting data on the sales, profits and costs of the customer group as a whole before and after the campaign are carried out. The managerial accounting data for the month preceding the campaign analysis date are added to the above-described campaign execution contents.

The customer database 12 includes customer attribute information, customer merchandise-purchase-record information, customer contact information, customer trouble information and customer managerial accounting information. Unlike merchandise or products information, these data provide information on each customer. It is to be noted here that in this patent application, the terms “goods,” “merchandise,” and “product” are interchangeably used throughout.

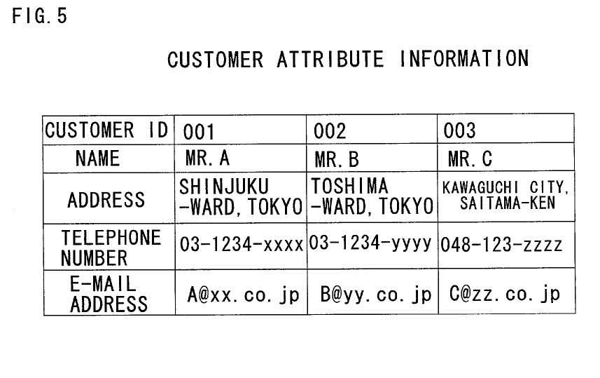

Customer attribute information is information that includes each customer's ID, name, address, telephone number and Email address (see FIG. 5.).

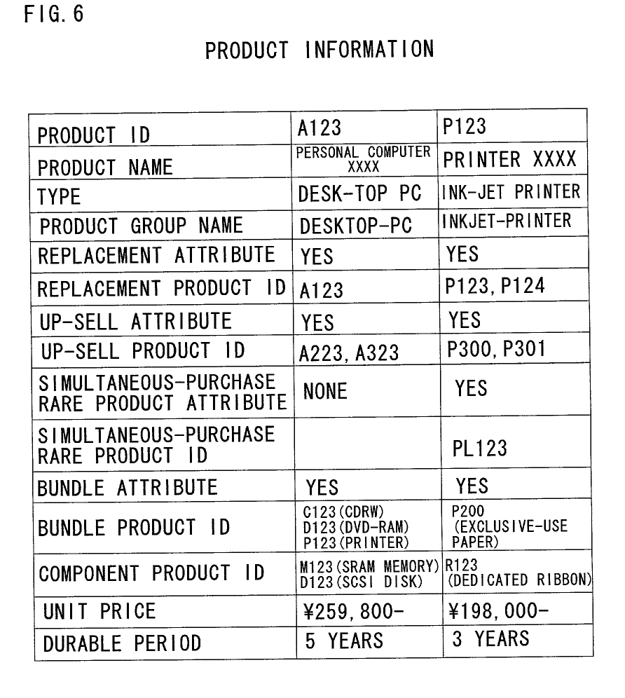

Product information stored in the product information memory 11 includes a product ID, product name, type, group name, replacement attribute, replacement product ID, up-sell attribute, up-sell product ID, simultaneous-purchase rare product attribute, simultaneous-purchase rare product ID, bundle attribute, bundle product ID, product ID of parts, unit cost and durable period (see FIG. 6). The product ID of parts is stored only for ones which are to be proposed in the up-sell or replacement.

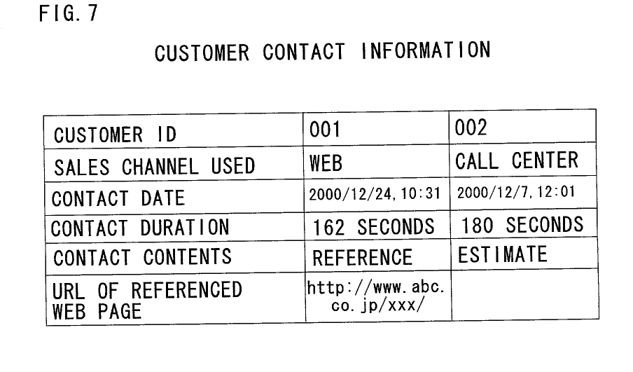

Customer contact information includes attributes of customer contact (customer ID, channel used, contact date, contact duration, contact contents, URL of referenced Web page, and so forth). This information is the contact history between customer and business provider (Web page and so forth), (see FIG. 7).

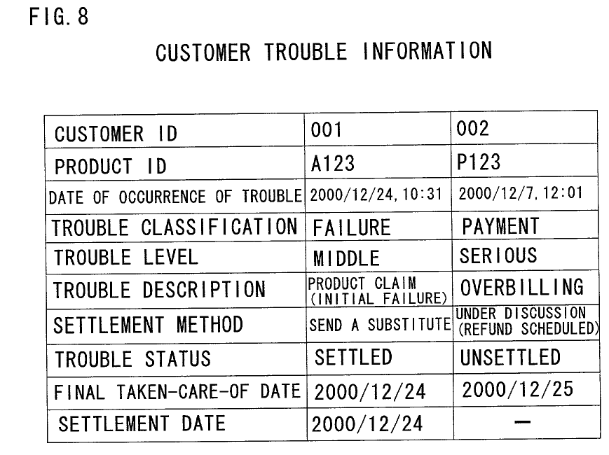

Customer trouble information includes attributes of customer trouble (customer ID, product ID, date of occurrence, trouble classification, trouble level, trouble description, settlement method, trouble status, final taken-care-of date, settlement date, and so forth), (refer to FIG. 8).

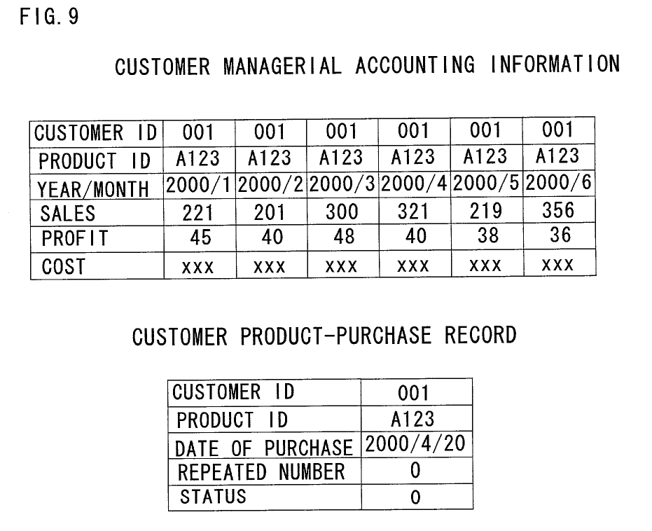

Customer managerial accounting information includes managerial accounting information on customers (customer ID, product ID, year and month, sales/profit/cost (yearly/monthly), and so forth), (refer to FIG. 9).

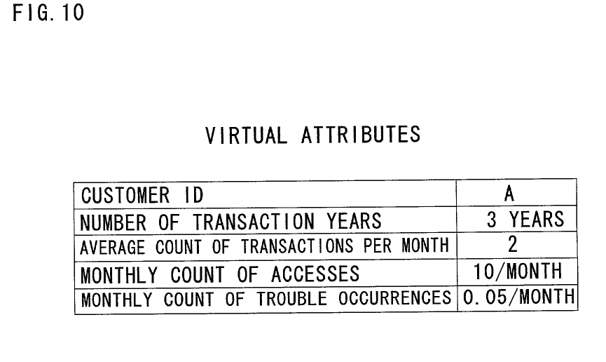

In contrast to the attributes provided by the customer database 12, attributes which are generated by this system are called “virtual attributes.” The virtual attributes are generated by the virtual attribute generator 13 based on data supplied from the customer database 12 and the server 3. The following items can be listed as the virtual attributes (refer to FIG. 10).

Number of transaction years.

Average count of transactions per month.

Monthly count of accesses to this Web site.

Monthly count of trouble occurrences, and so forth

The customer segment is a customer group extracted according to an appropriate condition or conditions, and the extracting condition is called the filter. The extraction filter 16 carries out a filtering process based on preset extracting condition or conditions.

The extraction filter 16 of this system performs the following customer extraction functions:

(1) Extraction of Prospective Customers (See Examples Below)

(1)-1 Customers Having Potential Demand

Belonging to this group of customers are the customers to whom cross-selling is possibly proposed and recommended, the customers to whom up-selling is possibly proposed and recommended, and the customers to whom replacement purchase is possibly proposed and recommended.

The product group will now be described hereinbelow:

Products are classified into groups on the criterion that when a customer who buys product A of a certain product group is approached with the intention of selling product B of another product group, there is basically no tendency of not purchasing product B because A has already been purchased (so there is little interdependence between A and B).

Basically, the definition of product groups is close to the grouping of products by type but is different in a point where priority is given to whether or not a cross-sell is possible.

A case where there is a tendency of purchasing B because A has been purchased is classified into a separate group (bundle attribute).

A case where there is a tendency of not purchasing B after A is purchased is classified into a separate group (rare simultaneous purchase attribute).

(Supplementary Explanation)

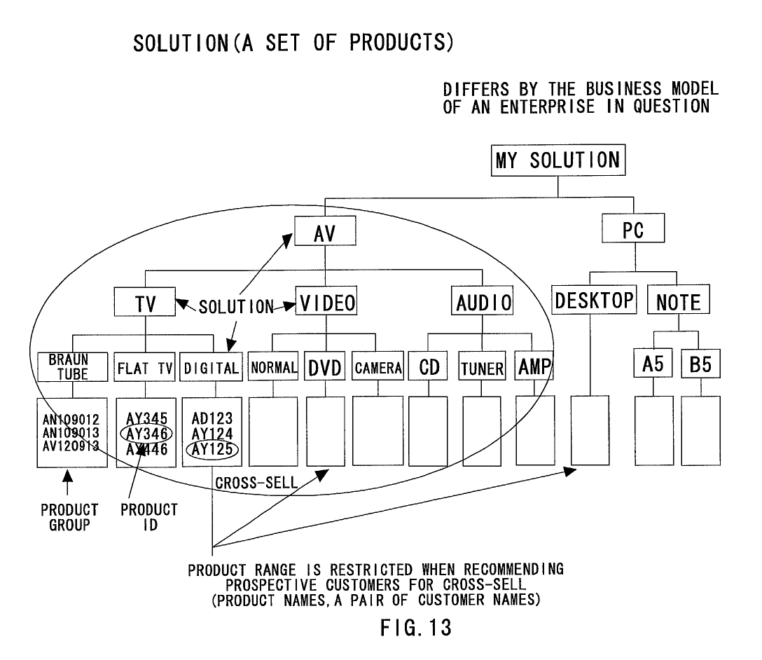

The product means a product, a service or a solution which is a set of products. See FIG. 13. The “solution” meant here may be interchangeably termed as product categories also.

The customer to whom cross-selling of product A is possibly proposed is any customer who has purchased a product of a product group other than that belonging to the product A and to whom the product A can be proposed. There are a product which is easily bought together with the already-purchased product (bundle attribute), and a product which is not easily bought together with it (rare simultaneous purchase attribute).

The conditions for extracting customers to whom the cross-selling of product A is possibly proposed are, for instance, as follows:

The product A has not been purchased yet.

A product of a group other than that of the product A has been purchased.

Any product designated as a product rarely purchased simultaneously with product A has not been purchased.

A customer who has purchased any product having the “bundle” affinity with the product A is to be weighted accordingly because there is a greater potential for a purchase.

The customer to whom up-selling of product A is possibly proposed is any customer who have already purchased a lower-grade product (product B) of product A and to whom the change to product A, which is an upper-grade product of the product B, can be proposed when the operating life limitation or term of validity of product B has passed or expired. Even at the expiry of the operating life limitation or term of validity of any of parts of the product B, the upgrade-purchase (up-sell) or replacement purchase is proposed.

The conditions for extracting customers to whom the up-sell to the product A is possibly proposed are, for instance, as follows:

The product A has not been purchased yet.

A lower-grade product (product B) of product A has been purchased.

The durable period of product B or any part thereof after the purchase has expired.

An up-sell of product B is possible.

Product A is included in up-sell products of product B.

An up-sell is possible to the parts of product B (in a case when the up-sell of the parts of product B is to be proposed).

The customer to whom the replacement of product A is possibly proposed is any customer who has already purchased the product A and to whom the replacement to a product A can be proposed when the operating life limitation or term of validity of product A has passed or expired. Even at the expiry of the operating life limitation or term of validity of any of the parts of product A, the replacement purchase is to be proposed.

The conditions for extracting customers to whom the replacement of product A is possibly proposed are, for instance, as follows:

The durable period of product A or any part thereof after the purchase has expired.

A replacement of Product A is possible.

Product A belongs to the products capable of replacing the product A (When the product ID has changed, the replacement by the product of new ID is to be proposed).

A replacement of the parts of product A is possible (in a case when the replacement of the parts of product A is to be proposed).

(1)-2 Customers Having Evidently Concrete Demand

The customers of this category include those who have inquired about the product or have asked for a quotation for it and those who have accessed and referred to the Web page for the product frequently.

(2) Extraction of Very Promising Customers

This is to extract customers whose importance to the seller is high, judging from the sales to or the profit from each customer.

The conditions for extracting the very promising customers are, for instance, as follows:

The sales to the customer in the year x are greater than y yen.

The average yearly increase of sales for the last x years is greater than y percent.

The profit from the customer is greater than y yen.

The average yearly increase of profit for the last x years is greater than y percent.

(3) Extraction of Customers whose Follow-Up is Necessary

This includes customers with whom some trouble has occurred and customers who have stopped accessing the site for a while.

The conditions for extracting the customers whose follow-up is necessary are, for instance, as follows:

There was some trouble in the past x months.

There was some trouble of level y or above in the past x months.

There were z times or more of troubles of level y or above in the past x months.

There has been no contact (access) to the Web page since the last date of trouble.

There has been no access for x days or more.

In today's mature market, seller enterprises cannot expect a steady yearly increase in their sales. Hence, their aim and concept are shifting to profit increase through cost reduction by cross-sell or up-sell to existing customers, restructuring and like measures rather than sales increase through costly steps of cultivating new customers. The important point here is the one-to-one analysis of the needs of existing customers and the realization of one-to-one marketing. It is said that “the loss of one existing customer is equal to the loss of 30 prospective customers on the grapevine.” Sellers cannot afford to lose their customers whom they have won at great cost; they must take some concrete action to retain their customers. Therefore it is of importance to extract prospective customers from existing customers, to further extract very promising customers who seem to produce profits as a result of sales and to extract, without delay and without fail, customers who need customer maintenance. Now the extraction filter 16 automatically extracts the customers as described in (1) to (3) above.

Next, concrete examples of filters will now be described. For example:

Number of transaction years ≅5 and Average count of transactions per month ≧2.

The extracting conditions of a filter are comprised of logical expressions of database items or virtual attributes and their comparison operators. They may also be a nest expression of this filter.

Filter=Expression (operator) Expression

Expression=Virtual attribute or database (DB) attribute or constants or Expression (operator) Expression

Operator=Logical expression (AND, OR, XOR) or comparison operators (= > < ≧ ≦ ≠) or Arithmetic expression for arithmetic operation (+, −, *, /).

For a filter, a filter of lower order can be defined. The lower order filter inherits all of the upper order filters.

The functions of a lower order filter can be changed by overwriting a part of the functions of the upper order filter, in the lower order filter.

Examples of source filters provided by this system are listed below:

Customer who has purchased product A.

Customer who has not purchased product A.

Customer who has purchased a cross-sell product of the product A.

Customer who has purchased a product having bundle attribute with product A, and also customer who has purchased a product having bundle attribute with product B, which is a cross-sell product of product A.

Customer who has not purchased a rare simultaneous-purchase product of product A.

Customer who has not bought a rare simultaneous-purchase product of product B, which is a cross-sell product of product A.

Customer who has not purchased an upper-order product of product A.

Customer who has purchased a lower-order product of product A.

Customer to whom up-sell is possible because the durable period of product A has expired.

Customer to whom up-sell is possible because the useful life of a lower-order product of product A has expired.

Customer to whom replace-sale is possible because the useful life of product A has expired.

Customer who has referred to the page for product A at the Web site y times or more in the last x months.

Customer who has accessed the Web site y times or more in the last x months.

Customer to whom the sales in the year x were y yen or more.

Customer to whom the average yearly increase in sales in the past x years is y percent or more

Customer from whom the profit in the year x was y yen or more.

Customer from whom the average yearly increase in profit in the past x years is y percent or more

Customer with whom there has been trouble in the last x months.

Customer with whom there has been trouble of level y or above in the last x months.

Customer with whom there have been z times or more of trouble of level y or above in the last x months.

Customer who has not contacted (accessed) the Web page since the last date of trouble.

Customer who has not accessed for more than x days.

According to the above-described preferred embodiments of the present invention, prospective customers for cross-sell, up-sell and replace-sell are extracted by the use of applicable product data and customers' product-purchase-record data. This is a top-down approach, and is different from the bottom-up approach in which one's experience or sixth sense is used in extracting prospective customers from customer data. Moreover, a viewpoint does not lie in the conventional practice of cultivating new customers, thus it is realizable when applied to business with existing customers.

The present invention is not limited by the above-described embodiments alone and various modifications thereto are possible within the scope described in the claims, and such the modifications are of course included in and encompassed by the scope the present invention.

Moreover, the means as referred to in this patent specification do not necessarily mean the physical means only, but also includes cases in which the function of each means is realized by software. Moreover, the function of one means may be realized by a plurality of physical means, and also the functions of a plurality of means may be realized by a single physical means.

According to the preferred embodiments as described above, a seller enterprise can carry out one-to-one marketing for each of its existing customers, in an active sales approach rather than in the conventional passive one, by using the list of “prospective customers to whom cross-sell, up-sell or replace-sell is possibly proposed” which is outputted from the computer. This system makes it possible to conduct an outbound marketing more easily, at lower cost and more speedily than the conventional database marketing that requires a sizable system investment and a dedicated marketing organization. In particular, the hardware which stores high-cost customer database and the cost for structuring a system therefor are significantly reduced.

The business supporting system and method according to the present embodiments realize a CRM oriented to order receiving management in which a seller side manages the product information and customers' purchase records so that the seller side can securely exploit the forthcoming opportunities for business or order receiving. Namely, the forthcoming business opportunities are created by the seller side, who positively manages information and takes action accordingly instead of passively waiting for the decision of customers to purchase.

For example, the system proves very effective in solving problems such as follows:

When a manufacturer has sold a product with a relatively long durable period to a customer, what would happen to the business action after the expiry of the product's durable period, depends heavily on factors that are difficult to be predicted, such as the capacity or transference of each of salespersons involved.

The business supporting system and method according to the present embodiments can, on its own, bring great benefits and merits to the users, but also, when added to the existing CRM system, can bring further effects without compromising the existing CRM system and method.

The existing CRM is a service system in which “customer data are collected and analyzed and then sales activities suited to individual customers are carried out in order to meet the needs of each customer.” However, it has an inherent problem that the sales activities tend to be operated for the convenience or advantage of the seller only. In contrast to this, the business supporting system and method according to the present embodiments run on the principles: (1) The seller enterprise, who best knows the product sold, structures the product database; (2) The information on the products purchased by each customer is added to the customer database; (3) The seller enterprise manages and analyzes (1) and (2) above and engages in active operations of cross-sell, up-sell, replace-sell and maintenance service; (4) The consistency of service by a seller enterprise is assured in (1), so that a consistent service to customers is provided as an enterprise without any detrimental effects that can result from the interests and convenience of individual salespersons or sales organization. These principles may even be represented by a coined word “CPRM” that stands for Customer and Product Relationship Management. The CPRM is characterized by its superior customer service performance, and supplements the CRM which is considered deficient in its ability to serve customers.

The business supporting system and method according to the present embodiments are general-purpose system and method which can be used in any type of business simply by customizing the product information database and the customer information database.

In the extraction of cross-selling-proposable products and prospective customers from a customer group having purchased an arbitrary product, this system may have a function of limiting the range of products to be proposed for cross-selling so that the proposed product does not surpass the seller's intention. To make sure that the proposed products do not go beyond the range of products that can be supplied by the sales department of the seller enterprise, a solution (products category) corresponding to the sales organization of the seller enterprise is defined so as to smoothly support the sales activities of the seller enterprise.

Since it is also possible to perform a managerial accounting analysis for each solution, a virtual solution can be defined and a time-series analysis is possibly made of the sales and profits for a group of products belonging to this virtual solution. It is to be noted here again that “solution” which is a set of products may be interchangeably termed as product categories also. Customers to be targeted are the prospective customers extracted by the present system or the customers extracted by the use of a filter or customized filter provided by the present system. Thereby, a managerial accounting analysis of a certain group of customers can be performed by the virtual solution, thus making possible a marketing simulation analysis.

Hierarchical diagrams for solutions are shown to customers, and they are each asked to register a solution by which they are willing to accept the delivery of electronic mail of product proposal. In the conventional extraction of prospective customers, the convenience of the seller only has tended to take precedence, and so there has always been a risk of customer service downgraded by sales approaches that are not desired by the customer. To avoid this risk, only the products of the solutions desired by the customers are proposed by electronic mail. As the solution is in a hierarchical structure, choice of an upper solution covers its lower solutions, thus expanding the range of products. Moreover, specifying a certain price range makes it possible to give guidance on products in that price range only.

Of all the mail sent to the customers in a campaign, each member of the sales staff can receive the electronic mail that satisfies the conditions, such as the product category, price range and customer names, which each sales staff member has registered in advance. The sales staff can receive in real-time the electronic mail sent to major customers or the electronic mail related to specific products.

Within the range of solutions desired by a prospective customer, there may be a part not proposed to the customer by the function that limits electronic mail to the customer. Such information, held unused by the request of the customer despite the assumed presence of potential needs, may be stored on a disk and can be put to use in the real-time recommendation in business or electronic commerce.

Second Embodiment

A second embodiment according to the present invention realizes a system which diversifies the prospective customer extracting functions described in the first embodiment. This prospective customer extracting function selects or narrows down sales targets specifically according to needs of a seller.

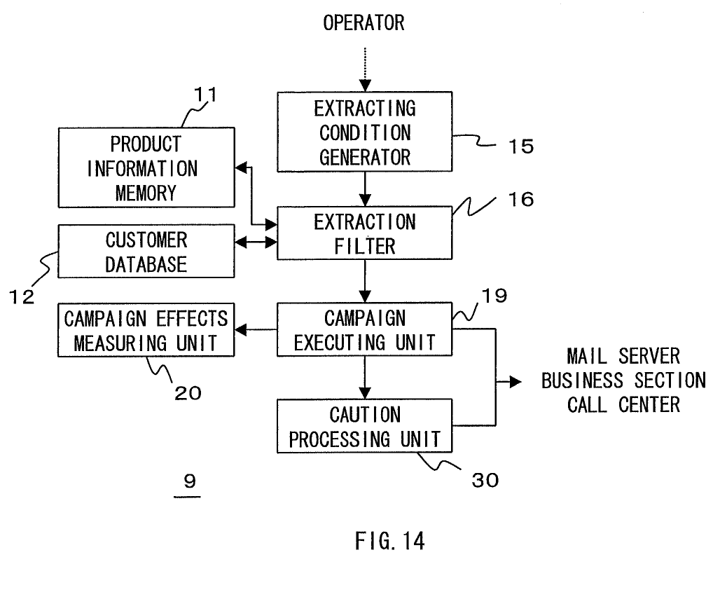

FIG. 14 is a functional block diagram showing a structure of a business supporting system according to a second embodiment. The business supporting system according to the second embodiment differs from the business supporting system according to the first embodiment in that the prospective customers are extracted by diverse techniques in such a way as to meet the desire and requirements of the seller. Aside from this basic difference, this system has substantially the same structure and functions as the system of the first embodiment, and therefore, the following description will mainly concern differences this present system provides.

The present system is realized by hardware, such as a CPU of a computer and other elements, and software, such as a program that has a prospective customer extracting function or customer narrowing-down function. FIG. 14 illustrates functional blocks which are realized by combination and cooperation of hardware and software. Thus, these functional blocks can be realized in various modalities by the combination of hardware and software.

A product information memory 11 stores characteristics and property of products and relations between the products. The characteristics and property of products, as meant here, include a type, a unit price and the durable period of the product, and the relations between the products include the relations subject to or considered for cross-sell, up-sell and replacement and the relations therebetween, the relation of products which are rarely purchased simultaneously, the relations that warrant a bundling, and the relations between the product and its parts or components. For example, if the product is “a systematically equipped kitchen”, the “wall paper” and “illumination” are in the “cross-sell” relationship with the former, and a “ventilating fan” and a “sink” are related as its parts. The durable period for each of the parts of the product are also stored. This is because the customers may be extracted according to the expiry of the durable period of any of the components of a product, irrespective of whether the useful life of the product has expired or not. As shown in FIG. 13, data on the products are stored by being grouped according to the business mode or strategy of the seller.

The product information memory 11 further stores the degree of association between products according to the cross-sell, up-sell and replacement records. Hereinafter, the terms “degree of association” and “relation level” will be interchangeably used. Furthermore, the product information memory 11 stores the number of purchasers and the counts of cross-sells, up-sells and replacement of each product.

A customer database 12 stores the purchase histories of products by the customers, the range of products registered in advance according to the preference of each customer, the accounting information managed for each customer, and the information on trouble with certain customers. The purchase histories meant here are attributes of the customers and the product purchase records or actual results of product purchase of each customer.

An extracting condition generator 15 generates conditions by which to extract prospective customers. Based on the conditions, an extraction filter 16 extracts prospective customers. The extraction filter 16 may restrict products intended for cross-sell, up-sell and replacement, based on information on grouped product categories.

A campaign executing unit 19 manages notices to prospective customers about product purchase recommendations or proposals. The campaign executing unit 19 judges whether or not a notice is to be sent by seeing whether or not the product recommended for purchase is included within the range of products registered by the customer, and then sends the notice to the customers only who are judged that the notice be sent. A caution processing unit 30 transmits caution information indicating that the contents of the notice of purchase proposal have satisfied a predetermined cautionary condition. In other words, when the contents of the notice of the purchase proposal satisfies the predetermined cautionary condition, the caution processing unit 30 transmits the cautionary information to this effect. This cautionary information is transmitted to, for instance, the business section of a seller enterprise or to a section or a person at a call center which makes direct contact with the customers. For example, customers who desire a telephone call or a direct visit instead of an electronic mail notice are registered in the cautionary conditions, and when the customers are extracted as prospective customers, the customers' intention described in the cautionary conditions as such is communicated to the business section side. Moreover, the registration as to which of the electronic mail, the business section or the call center is to be used as a route by which the customer receives the notices of purchase proposal may be acquired in advance through the procedure with each customer.

The campaign executing unit 19 may decide notifying destinations of the product purchase proposal, based on said registration. The campaign executing unit 19 stores the information on purchase proposals, irrespective of the presence or absence of the notice thereof, and, when the campaign executing unit 19 has received an inquiry from a customer, performs a processing in which a product or products to be proposed to the customer is/are extracted and presented by referring to this.

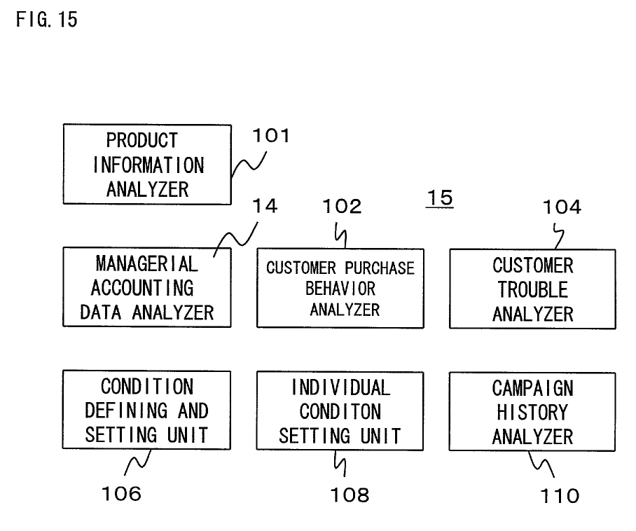

FIG. 15 is a functional block diagram showing a detailed structure of the extracting condition generator. The extracting condition generator 15 includes a product information analyzer 101, a managerial accounting data analyzer 14, a customer purchase behavior analyzer 102, a customer trouble analyzer 104, a condition defining and setting unit 106, an individual condition setting unit 108 and a campaign history analyzer 110.

The product information analyzer 101 generates conditions for extracting prospective customers, with emphasis placed on a sales timing of a product. The product information analyzer 101 also generates conditions for extracting prospective customers who indicates a demand for a cross-sell, up-sell or replacement to a new product, based on the characteristics and property of products, the relations between the products and the purchase history of products by customers. These conditions include, in addition to the methods of extracting customers described in the first embodiment, the techniques of extraction by the six ways of weighting as described hereinbelow. The seller can use any of these techniques at his/her option.

(1) The product information analyzer 101 generates an operation expression where a purchase-prospect degree for each of sale-prospective customers is calculated based on relation level between products and this calculated purchase-prospect degree is added to the extraction results of sale-prospective customers as weighting factors. For example, when extracting prospective customers for the cross-selling of product a, a group of customers who purchased the product a in the past is first extracted and, at the same time, products that have cross-sell relationship with the product a are extracted. Now suppose that its cross-sell products are b, c and d, and the relation levels of the products b, c and d with the product a are 10, 50 and 100, respectively. Then, the prospective customers for each of the products b, c and d are extracted by the method described in the first embodiment. Then, the prospect degree of purchase by each prospective customer is calculated based on the relation level between products, and this calculated purchase-prospect degree is added, as the weighting, to the results of extraction of prospective customers. For example, assume that the prospective customers for product b are X and Z, the prospective customer for product c is X, and the prospective customer for product d is Y. Then, since the customer X is expected to purchase products b and c, the purchase-prospect degree of X is such that purchase_prospect_degree(X)=relation_level(b) +relation_level(c)=10+50=60. Similarly, for the customer Y in his/her relationship with product d, purchase_prospect_degree(Y)=relation_level(d) =100. For the customer Z in his/her relationship with product b, purchase_prospect_degree(Z)=relation_level(b)=10. The prospective customers for each of the products, sorted out in the order of the purchase-prospect degrees, are in the order of customer Y, customer X and customer Z in the above example.

(2) The product information analyzer 101 generates an operation expression where a purchase-prospect degree for each of sale-prospective customers is calculated based on relation level between products and this calculated purchase-prospect degree is added to the extraction results of sale-prospective customers as weighting factors. For example, when extracting prospective customers for product a which is to be cross-sold from among customers who have purchased a certain product, the prospective customers are extracted by the method described in the first embodiment. Then, the prospect degree of purchase by each prospective customer is calculated based on the relation level between products, and this calculated purchase-prospect degree is added, as the weighting, to the results of extraction of prospective customers. To find the relation level between the products, the products that have a cross-sell relationship with product a are first extracted. Now suppose that its cross-sell products are b, c and d, and prospective customers for the product a are X, Y and Z. Moreover, suppose that the relation levels of the products b, c and d with the product a are 10, 50 and 100, respectively. Assume that customers who have purchased product b are X and Z, a customer who has purchased product c is X and a customer who has purchased product d is Y. Then, since the customer X has purchased both the product b and the product c, the purchase-prospect degree of X is expressed as purchase_prospect_degree(X)=relation_level(b) +relation_level(c)=10+50=60. Similarly, since the customer Y has purchased the product d, the purchase-prospect degree of Y is expressed as purchase_prospect_degree(Y)=relation_level(d)=100. Similarly, since the customer Z has purchased the product b, the purchase-prospect degree of Z is expressed as purchase_prospect_degree(Z)=relation level(b)=10. The prospective customers for the product a, sorted out in the order of the purchase-prospect degrees, are in the order of customer Y, customer X and customer Z in the above example.

(3) The product information analyzer 101 generates an operation expression where the ratios of the counts of at least one of cross-sell, up-sell and replacement of the product to the number of purchasers are calculated and this calculated ratio is added to the extraction results of sale-prospective customers as weighting factors. For example, suppose that the numbers of purchasers of products b, c and d are 20, 80 and 120, respectively, in the example of (1) above, then the prospect degrees of purchase are as follows. For customer X, the purchase-prospect degree regarding X is expressed as purchase_prospect_degree(X)=relation_level(b/20)+relation_level(c/80)=0.5+0.625=1.125. Similarly, the purchase-prospect degree with respect to the customer Y is expressed as purchase_prospect_degree(Y)=relation_level(d/120)=0.833. Similarly, the purchase-prospect degree with respect to the customer Z is expressed as purchase_prospect_degree(Z)=relation level(b/20)=0.5. The prospective customers for each of the products, sorted out in the order of the purchase-prospect degrees, are in the order of customer Y, customer X and customer Z.

(4) The product information analyzer 101 generates an operation expression where the ratios of the counts of at least one of cross-sell, up-sell and replacement of the product to the number of purchasers are calculated and this calculated ratio is added to the extraction results of sale-prospective customers as weighting factors. For example, suppose that the numbers of purchasers of products b, c and d are 20, 80 and 120, respectively, in the example of (2) above, then the prospect degrees of purchase are as follows. For customer X, the purchase-prospect degree regarding X is expressed as purchase_prospect_degree(X)=relation_level(b/20)+relation_level(c/80)=0.5+0.625=1.125. Similarly, the purchase-prospect degree with respect to the customer Y is expressed as purchase_prospect_degree(Y)=relation_level(d/120)=0.833. Similarly, the purchase-prospect degree with respect to the customer Z is expressed as purchase_prospect_degree(Z)=relation_level(b/20)=0.5. The prospective customers for each of the products, sorted out in the order of the purchase-prospect degrees, are in the order of customer Y, customer X and customer Z.

(5) The product information analyzer 101 generates an operation expression where a purchase-prospect degree for each of sale-prospective customers is calculated based on relation level between products and this calculated purchase-prospect degree is added to the extraction results of sale-prospective customers as weighting factors. For example, when extracting prospective customers for the cross-selling of product a, a group of customers who purchased the product a in the past is first extracted and, at the same time, products that have cross-sell relationship with the product a are extracted. Now suppose that its cross-sell products are b, c and d, and the relation levels of the products b, c and d with the product a are 10, 50 and 100, respectively. Then, the prospective customers for each of the products b, c and d are extracted by the method described in the first embodiment. Then, from the relation levels between the products, the purchase-prospect degree of product b that is purchase_prospect_degree(b) becomes 10; the purchase-prospect degree of product c that is purchase_prospect_degree(c) becomes 50; and the purchase-prospect degree of product d that is purchase_prospect_degree(d) becomes 100. Each of the products is sorted out in the order of the purchase-prospect degrees, and the order of the purchase-prospect degrees for the products is the sequence of d, c and b in this example.

(6) The product information analyzer 101 generates an operation expression where the ratios of the counts of at least one of cross-sell, up-sell and replacement of the product to the number of purchasers are calculated and this calculated ratio is added to the extraction results of sale-prospective customers as weighting factors. For example, when extracting prospective customers for the cross-selling of product a, a group of customers who purchased the product a in the past is first extracted and, at the same time, products that have cross-sell relationship with the product a are extracted. Now suppose that its cross-sell products are b, c and d, and the relation levels of the products b, c and d with the product a are 10, 50 and 100, and, moreover, the numbers of the purchasers thereof are 20, 80 and 120 respectively. The prospective customers for each of the products b, c and d are extracted by the method described in the first embodiment.

Then, from the relation level between the products and the number of purchasers, the purchase-prospect degree of product b that is purchase_prospect_degree(b/20) becomes 0.5; the purchase-prospect degree of product c that is purchase_prospect_degree(c/80) becomes 0.625; and the purchase-prospect degree of product d that is purchase_prospect_degree(d/120) becomes 0.833. Each of the products is sorted out in the order of the purchase-prospect degrees, and the order of the purchase-prospect degrees for the products is the sequence of d, c and b in this example.

The managerial accounting data analyzer 14 generates conditions for extracting sale-prospective customers based on the sales, profits, their rates of increase and their ranking in the product purchases, summated using at least one of the customer data (data for each one of the customers), the purchased product data (data for each one of the purchased products) and the purchase-month data (data for monthly purchase) contained in the accounting information. For example, the extraction is carried out by such condition as “sales of ∘∘ yen and above,” “top ∘∘ customers in terms of profit” or “top ∘∘ percent in terms of the rate of increase.” This allows the extraction of very promising customers who are expected to purchase with increased probability.

The managerial accounting data analyzer 14 may reorganize and reconstruct accounting information into the information limited to the products included in the range of products registered by each customer, so as to be referred to. For example, when the range of products registered by each customer does not match the business mode of the seller, the accounting information is reorganized and reconstructed by temporarily using a grouping different from the business mode. Thereby, accounting situations can be analyzed from various aspects.

The customer purchase behavior analyzer unit 102 generates conditions for extracting the prospective customers based on the amount, unit price and frequency of purchase, their rates of increase and their ranking, and the last date of purchase of the products, summated using at least either of the customer data (data for each one of the customers) and the purchased product data (data for each one of the purchased products) contained in the accounting information. For example, the extraction is carried out by such conditions as “purchase of ∘∘ yen and above,” “top ∘∘ customers in terms of purchase frequency” or “top ∘∘ percent in terms of the rate of increase.” The customer trouble analyzer 104 generates conditions for extracting prospective customers based on the contents or type, frequency and count of troubles, and their ranking and the last date of occurrence contained in the information on troubles. For example, the extraction is carried out by such conditions as “number of troubles: less than ∘∘ times” or “last date of occurrence: before ∘ month/∘ day.” This way, the repetition of trouble can be prevented beforehand.

The condition defining and setting unit 106 generates conditions for extracting prospective customers through the verification of the expected extraction that reflects wishes and requirements of the seller. The condition defining and setting unit 106 receives the wishes and requirements of the seller from an operator, and then generates its condition based on them. The condition may be structured by statements, such as an IF statement, or by freely combining a number of operation expressions with logical expressions, such as AND and OR. The one's own weighting may be set, too. Specific examples will be described hereinbelow.

The seller defines a rule base reflecting his/her wishes and requests in a IF-THEN form. The rule base is defined in the form, for example, “IF Attribute=∘∘ THEN SCORE=SCORE+80”, “IF Attribute=∘∘ THEN SCORE=SCORE-300” or the like. The attribute as meant here is a factor by which to judge the prospect of purchase of a product, but may also be a risk factor by which to determine possibility of non-purchase of a product. The statement that follows “THEN” may be described using a function or script language. This rule is interpreted and executed by the condition defining and setting unit 106. As a result of the execution, the prospect degree of purchase by a customer is calculated. Upon confirming this purchase-prospect degree, the seller specifies narrowing-down methods, such as “∘∘ or above,” “top ∘∘ persons” or “top ∘∘ percent.” Through these processes, the conditions for extracting prospective customers are generated. Since the seller defines the rule base while confirming the expected extraction, the wishes and requirements of the seller are further faithfully reflected on the conditions.

The individual condition setting unit 108 generates conditions of extraction in such a way that the operator of this system specifies specific customers individually. The campaign history analyzer 110 extracts sale-prospective customers, based on the history of notices of purchase recommendation and proposal by the campaign executing unit 19. For example, this approach is effective in narrowing down the customers who have purchased a product in response to the notice of purchase recommendation. In this manner, the extracting condition generator 15 generates conditions for extracting sale-prospective customers by combining the techniques of extraction indicated at each of the functional blocks, based on the wishes and requests of the seller.

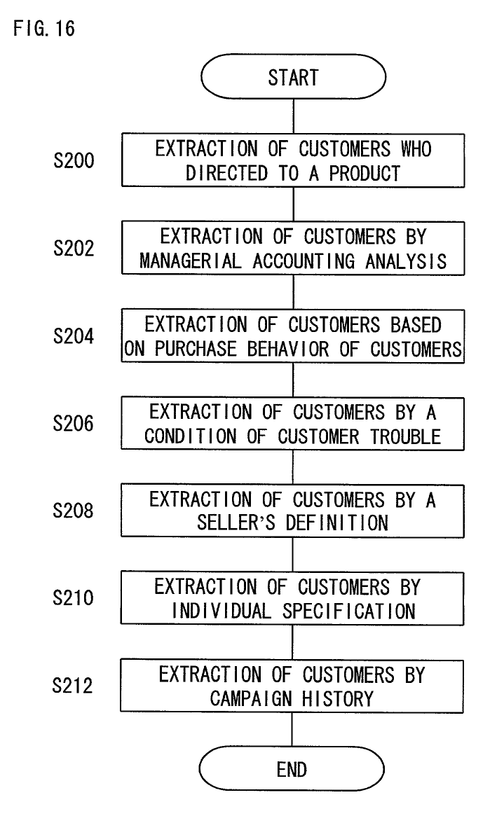

FIG. 16 is a flowchart showing a process of extracting prospective customers. First, prospective customers are extracted by a technique with attentions directed to a sale timing by the extraction filter 16 (S200), prospective customers are extracted by a managerial accounting analysis (S202), and prospective customers are extracted based on the purchase behavior of customers (S204). Moreover, prospective customers are extracted by a condition of customer trouble (S206), prospective customers are extracted by the definition chosen by the seller (S208), prospective customers are extracted by individual specification (S210), and prospective customers are extracted by campaign history (S212). In the present embodiment, extraction is carried out in a total of seven stages of S200 to S212. In modifications thereto, however, these extraction techniques may be executed in various combinations in any arbitrary manner.

Although the present invention has been described by way of exemplary embodiments, it should be understood that many changes, substitutions and various modifications to each of those constituting elements and processing processes by arbitrary combination thereof may be made by those skilled in the art without departing from the scope of the present invention which is defined by the appended claims and also that those changes, substitutions and various modifications are encompassed by the scope of the present invention.

What is claimed is:

1. A business supporting method, including:
extracting a prospective customer who indicates a demand for at least one of a cross-sell, up-sell and replacement to a new product, based on at least one of a property of products and a relation between the products and based on a customer product purchase history; and
displaying the prospective customer on a screen,
whereby customers having potential demands are revealed.

2. A business supporting system, comprising:
a product information storage which stores at least one of a property of products and a relation between the products;
a customer information storage which stores a customer product purchase history;
an extracting condition generator which generates a condition for extracting a prospective customer who indicates a demand for at least one of a cross-sell, up-sell and replacement to a new product, based on at least one of the property of products and the relation between the products and based on the customer product purchase history; and
an extraction processing unit which extracts the prospective customer based on the condition.

3. A business supporting system according to claim 2, wherein said product information storage stores, as the property of the products, any one of a type, unit cost and durable period of the products.

4. A business supporting system according to claim 2, wherein said product information storage stores, as the relation between the products, at least any one of a relation possibly related to a cross-sell, relation possibly related to an up-sell, relation possibly related to a replacement, relation related to rare simultaneous purchase, relation possibly related to a highly correlative cross-sell and a relation between the product and a component thereof.

5. A business supporting system according to claim 2, wherein said customer information storage stores, as the purchase history, at least one of a customer attribute and a product purchase record for each customer.

6. A business supporting system according to claim 2, wherein, in order to extract a prospective customer to whom a cross-sell for any product is to be proposed, after a product capable of being compatible with a product to be proposed for the cross-sell and a product incapable of being compatible with the product have been extracted from said product information storage, said extracting condition generator generates a condition for extracting a customer who has not yet purchased the product to be proposed for the cross-sell, and has already purchased the product capable of being compatible with the product to be proposed for the cross-sell and has not purchased the product incapable of being compatible with the product to be proposed for the cross-sell.

7. A business supporting system according to claim 2, wherein, in order to extract a prospective customer to whom a cross-sell for other products is to be proposed among customers who have purchased any product, after a product capable of being compatible with the any product has been extracted as a product proposed for the cross-sell from said product information storage and after a product incapable of being compatible with the product proposed for the cross-sell has been extracted from said product information storage, said extracting condition generator generates a condition for extracting a customer who has not yet purchased the product proposed for the cross-sell and who has not purchased the product incapable of being compatible with the product proposed for the cross-sell.

8. A business supporting system according to claim 3, wherein, in order to extract a prospective customer to whom an up-sell for any product is to be proposed, after a lower-order product of a product proposed for the up-sell has been extracted from said product information storage, said extracting condition generator generates a condition for extracting a customer who has already purchased the lower-order product whose durable period nearly expires or has expired and who has not yet purchased the product proposed for the up-sell.

9. A business supporting system according to claim 3, wherein, in order to extract, from customers who have purchased any lower-order product, a prospective customer to whom an up-sell for an upper-order product is to be proposed, after the upper-order product where an up-sell can be proposed relative to the lower-order product has been extracted from said product information storage, said extracting condition generator generates a condition for extracting a customer who has purchased a lower-order product whose durable period nearly expires or has expired and who has not yet the upper-order product.

10. A business supporting system according to claim 3, wherein, in order to extract a customer to whom a replacement of a product is to be proposed, said extracting condition generator generates a condition for extracting a customer who has already purchased the product whose durable period nearly expires or has expired.

11. A business supporting system according to claim 3, wherein, irrespective of expiry of any one of the products, said extracting condition generator generates a condition for extracting a customer who has at least a component, constituting the products, whose durable period thereof nearly expires or has expired.

12. A business supporting system according to claim 2, wherein said customer information storage further stores a relation level between the products in response to an actual record of any one of the cross-sell, up-sell and replacement, and wherein, as the condition, said extracting condition generator generates an operation expression where a purchase-prospect degree for each of the prospective customers is calculated based on the relation level between the products and the calculated purchase-prospect degree is added to an extraction result of the prospective customers as weighting factors.

13. A business supporting system according to claim 2, wherein said product information storage further stores the number of purchasers for each of the products and the count of the cross-sell, up-sell and replacement for each of the products, and wherein, as the condition, said extracting condition generator generates an operation expression where a ratio of the count of at least one of the cross-sell, up-sell and replacement of the product to the number of purchasers are calculated and the calculated ratio is added to an extraction result of the prospective customers as weighting factors.

14. A business supporting system according to claim 2, wherein said product information storage further stores information of product categories obtained by grouping for the products in response to a modality of a seller, and wherein said extracting condition generator restricts a range of a product for the cross-sell, up-sell and replacement, based on the information of product categories.

15. A business supporting system according to claim 2, further comprising a campaign executing unit which manages a notice to the prospective customer about a product purchase proposal.

16. A business supporting system according to claim 15, wherein said customer information storage further stores a range of products registered in advance according to a preference of each customer, and said campaign executing unit determines whether or not the notice be sent, based on whether or not a product proposed in the product purchase proposal is included in the range of products.

17. A business supporting system according to claim 16, further comprising a caution processing unit which transmits caution information when contents of the notice of the purchase proposal satisfies a predetermined cautionary condition.

18. A business supporting system according to claim 15, wherein said campaign executing unit stores information to be notified as the product purchase proposal, irrespective of the presence or absence of the notice, and, when an inquiry is received from a customer, said campaign executing unit performs a processing in which a product to be proposed to the customer is extracted and presented by referring to said information.

19. A business supporting system according to claim 15, wherein, in said campaign executing unit, registration as to which of electronic mail, a business section or a call center is to be used as a route by which a customer receives the notice of the purchase proposal is acquired in advance through a procedure with each customer, and a notifying destination of the purchase proposal is determined based on said registration.

20. A business supporting system according to claim 2, wherein said customer information storage further stores accounting information managed for each customer, and said extracting condition generator further generates a condition for extracting a prospective customer based on at least one of sales, profits, rates of increase thereof and ranking thereof in product purchases, summated using at least one of customer data, purchased product data and monthly purchase data contained in the accounting information.

21. A business supporting system according to claim 20, wherein said customer information storage further stores a range of products registered in advance in accordance with each customer's preference, and said extracting condition generator reconstructs and then refers to the accounting information in a manner such that the products are restricted to those included in the range.

22. A business supporting system according to claim 2, wherein said customer information storage further stores accounting information managed for each customer, and said extracting condition generator further generates a condition for extracting a prospective customer based on at least one of amount, unit price and frequency of purchase, rates of increase thereof and ranking thereof, and latest date of purchase, summated using at least one of customer data and purchased product data contained in the accounting information.

23. A business supporting system according to claim 2, wherein said customer information storage further stores information on a trouble that has occurred to a customer regarding a product, and said extracting condition generator further generates a condition for extracting a prospective customer based on at least one of contents, frequency and count of troubles, and ranking thereof and latest date of occurrence contained in the information on the trouble.

24. A business supporting system according to claim 2, wherein said extracting condition generator further generates a condition for extracting a prospective customer in a manner such that a requirement from a seller is reflected thereon in a form of a rule base.

25. A business supporting system according to claim 24, wherein said extracting condition generator receives the requirement from the seller regarding extraction contents, and generates the condition in a form such that a prospect degree of purchase is calculated by the rule base based on the received requirement from the seller.

26. A business supporting system according to clam 2, wherein said extracting condition generator further generates a condition where an operator of the system specifies a specific customer.

27. A business supporting system according to clam 2, wherein said extracting condition generator further generates a condition for extracting a prospective customer based on a history of notices on a purchase proposal for the product.

28. A business supporting system according to claim 20, wherein said extracting condition generates the condition, based on a requirement from a seller, by combining various extraction techniques.

29. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including at least two or more of the functions of:
generating the condition based on at least one of sales, profits, rates of increase thereof and ranking thereof in product purchases, summated using at least one of customer data, purchased product data and monthly purchase data contained in the customer information;
generating the condition based on at least one of amount, unit price and frequency of purchase, rates of increase thereof and ranking thereof, and latest date of purchase, summated using at least one of customer data and purchased product data contained in the customer information;
generating the condition based on at least one of contents, frequency, count, ranking thereof and latest date of occurrence of product-related troubles contained in the customer information;
generating the condition in a manner such that a seller's requirement is defined by an operation expression;
generating the condition in a manner such that an operator of the system specifies a specific customer; and
generating the condition based on a history of notices on a purchase proposal for the product.

30. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition, said extracting condition generator including the functions of:
generating the condition based on at least one of sales, profits, rates of increase thereof and ranking thereof in product purchases, summated using at least one of customer data, purchased product data and monthly purchase data contained in the customer information; and
generating the condition based on at least one of amount, unit price and frequency of purchase, rates of increase thereof and ranking thereof, and latest date of purchase, summated using at least one of customer data and purchased product data contained in the customer information.

31. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of sales, profits, rates of increase thereof and ranking thereof in product purchases, summated using at least one of customer data, purchased product data and monthly purchase data contained in the customer information; and
generating the condition based on at least one of contents, frequency, count, ranking thereof and latest date of occurrence of product-related troubles contained in the customer information.

32. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition, said extracting condition generator including the functions of:
generating the condition based on at least one of sales, profits, rates of increase thereof and ranking thereof in product purchases, summated using at least one of customer data, purchased product data and monthly purchase data contained in the customer information; and
generating the condition in a manner such that a seller's requirement is defined by an operation expression;

33. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of amount, unit price and frequency of purchase, rates of increase thereof and ranking thereof, and latest date of purchase, summated using at least one of customer data and purchased product data contained in the customer information; and
generating the condition based on at least one of contents, frequency, count, ranking thereof and latest date of occurrence of product-related troubles contained in the customer information.

34. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of amount, unit price and frequency of purchase, rates of increase thereof and ranking thereof, and latest date of purchase, summated using at least one of customer data and purchased product data contained in the customer information; and
generating the condition in a manner such that a seller's requirement is defined by an operation expression.

35. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of contents, frequency, count, ranking thereof and latest date of occurrence of product-related troubles contained in the customer information; and
generating the condition in a manner such that a seller's requirement is defined by an operation expression.

36. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of sales, profits, rates of increase thereof and ranking thereof in product purchases, summated using at least one of customer data, purchased product data and monthly purchase data contained in the customer information;
generating the condition based on at least one of amount, unit price and frequency of purchase, rates of increase thereof and ranking thereof, and latest date of purchase, summated using at least one of customer data and purchased product data contained in the customer information; and
generating the condition based on at least one of contents, frequency, count, ranking thereof and latest date of occurrence of product-related troubles contained in the customer information.

37. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of sales, profits, rates of increase thereof and ranking thereof in product purchases, summated using at least one of customer data, purchased product data and monthly purchase data contained in the customer information;
generating the condition based on at least one of amount, unit price and frequency of purchase, rates of increase thereof and ranking thereof, and latest date of purchase, summated using at least one of customer data and purchased product data contained in the customer information; and
generating the condition in a manner such that a seller's requirement is defined by an operation expression.

38. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of sales, profits, rates of increase thereof and ranking thereof in product purchases, summated using at least one of customer data, purchased product data and monthly purchase data contained in the customer information;
generating the condition based on at least one of contents, frequency, count, ranking thereof and latest date of occurrence of product-related troubles contained in the customer information; and
generating the condition in a manner such that a seller's requirement is defined by an operation expression.

39. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of amount, unit price and frequency of purchase, rates of increase thereof and ranking thereof, and latest date of purchase, summated using at least one of customer data and purchased product data contained in the customer information;
generating the condition based on at least one of contents, frequency, count, ranking thereof and latest date of occurrence of product-related troubles contained in the customer information; and
generating the condition in a manner such that a seller's requirement is defined by an operation expression.

40. A business supporting system, comprising:
a product information storage which stores information on products;
a customer information storage which stores information on a customer who has purchased a product;
an extracting condition generator which generates a condition for extracting a prospective customer; and
an extraction processing unit which extracts the prospective customer based on the condition,
said extracting condition generator including the functions of:
generating the condition based on at least one of sales, profits, rates of increase thereof and ranking thereof in product purchases, summated using at least one of customer data, purchased product data and monthly purchase data contained in the customer information;
generating the condition based on at least one of amount, unit price and frequency of purchase, rates of increase thereof and ranking thereof, and latest date of purchase, summated using at least one of customer data and purchased product data contained in the customer information;
generating the condition based on at least one of contents, frequency, count, ranking thereof and latest date of occurrence of product-related troubles contained in the customer information; and
generating the condition through verification of expected extraction that reflects a seller's requirement.

41. A computer program executable by a computer, the program comprising the functions of:
storing at least one of a property of products and a relation between the products;
storing a customer product purchase history;
generating a condition for extracting a prospective customer who indicates a demand for at least one of a cross-sell, up-sell and replacement to a new product, based on at least one of the property of products and the relation between the products and based on the customer product purchase history; and
extracting the prospective customer based on the condition.
